(19) United States
(12) Patent Application Publication
(10) Pub. No.: US 2022/0356735 A1
(43) Pub. Date: Nov. 10, 2022

(54) A LOCKING SYSTEM USED IN ACCESSORY AND JEWELLERY

(71) Applicant: Rober TAS, Istanbul (TR)

(72) Inventor: Rober TAS, Istanbul (TR)

(21) Appl. No.: 17/625,495

(22) PCT Filed: Jan. 25, 2021
(86) PCT No.: PCT/TR2021/050060

§ 371 Date: Jan. 7, 2022

(30) Foreign Application Priority Data
Jan. 30, 2020 (TR) 2020/01440

(51) Int. Cl. E05B 63/00; A44C 19/00; E05B 67/22

(52) U.S. Cl. CPC E05B 63/0043; A44C 19/00; E05B 67/22

(57) ABSTRACT

A locking system has a housing and a spring positioned in a body. The system has a locking element on which a spring is attached such that the locking system is inside the housing, and provides locking. At least one fixing element is engaged with the housing, and enables the locking element to be fixed to the housing. At least one guide element is combined with the locking element, and allows the spring to remain on the locking element and the locking element to move in the housing. At least one ring is connected with the guide element and the locking element and ensures the fixation of the locking element to the housing.

### TECHNICAL FIELD

The invention relates to locking system to be used in accessory and jewellery.

### STATE OF THE ART

Today, locking systems are used as the most essential element when security measures are taken. Widely preferred padlock systems generally have a mechanical or electrochemical operating systems, they are locked with various keys or password combinations. Except precaution purposes, the padlock systems can also be used in the field of accessories and jewellery.

In the state of the art, the use of padlock systems in the field of accessory and jewellery is not widespread; however there is a requirement for locking mechanisms that occupy less space and offer a practical use in this field.

In the abstract of the patent application numbered U.S. Pat. No. 7,174,756B2 seen as a result of the research made in terms of the subject; it is mentioned that the application comprises; a housing, a clamp with a free first end and a second end, a locking mechanism remained in the housing and limiting the axial movement of the second end of the clamp, a ratchet tube and clamp that operates to be moved within the housing.

In another patent application numbered U.S. Pat. No. 6,539,761B2 seen as a result of a research in terms of the subject, a lock body is stated that it comprises; a clamp that is functionally locked or locked to the lock body, locking device operated by a key formed in the lock body to unlock the padlock and a combination locking device formed side by side in the lock body for functional opening of the lock body to unlock the padlock by only turning the combination.

A utility model application numbered 2016/07465 seen as a result of a research in terms of the subject relates to an electromechanical padlock that provides advantages since it does not embody a keyhole, does not require an externally connected energy and provides maximum security, is developed to be used particularly in areas such as prisons, warehouses etc. where padlocks with keys are used.

The abovementioned systems mainly relate to padlock systems, however a structure that can provide solution to the abovementioned disadvantages is not mentioned. Examples of these systems are currently used padlock mechanisms. However, it is not usable for the jewellery industry. It is not practical and useful for opening and closing the jewellery with the use of a key or password.

As a result, due to the abovementioned disadvantages and the insufficiency of the current solutions regarding the subject matter, a development is required to be made in the relevant technical field.

### AIM OF THE INVENTION

The invention aims to provide a structure having different technical features which brings a new development in this field different from the embodiments used in the state of the art.

The primary aim of the invention is to allow the user to manually open and close the lock without any concern in terms of a key or password.

An aim of the invention is to eliminate the opening and closing difficulty.

Another aim of the invention is to prevent the precious metal from scratching by rotating the same 360 degrees above a certain level while the lock is opened.

Another aim of the invention is to provide ease of use, since the locking element can automatically lock itself when it comes to the locking level.

Another aim of the invention is to provide the lock system to be used in various sizes and various body designs.

In order to fulfil the abovementioned aims, the present invention is a locking system with a housing and a spring positioned in a body, comprising; a locking element on which a spring is attached such that the locking system is inside the housing, and provides locking, at least one fixing element that is engaged with the housing, enables the locking element to be fixed to the housing, at least one guide element combined with the locking element, allows the spring to remain on the locking element and the locking element to move in the housing, at least one ring that is connected with the guide element and the locking element and ensures the fixation of the locking element to the housing.

The structural and characteristic features of the present invention will be understood clearly by the following drawings and the detailed description made with reference to these drawings and therefore the evaluation shall be made by taking these figures and the detailed description into consideration.

### FIGURES OF THE INVENTION

FIG. 1, shows the use of the locking system with jewellery.

FIG. 2, shows the perspective view of the locking system.

FIG. 3, shows the front perspective view of inner structure of the locking system.

FIG. 4, shows the side perspective view of inner structure of the locking system.

FIG. 5, shows the detail perspective view of inner structure of the locking system.

FIG. 6, shows the detail perspective view of inner structure of the locking system.

### DESCRIPTION OF THE PART REFERENCES

100—Door system

110—Body

111—Upper Body

120—Housing

130—Carrier Element

140—Locking Element

141—Spring section

150—Fixing element

160—Spring

170—Guide Element

180—Ring

### DETAILED DESCRIPTION OF THE INVENTION

In this detailed description, the preferred embodiments of the invention is described only for clarifying the subject matter in a manner such that no limiting effect is created.

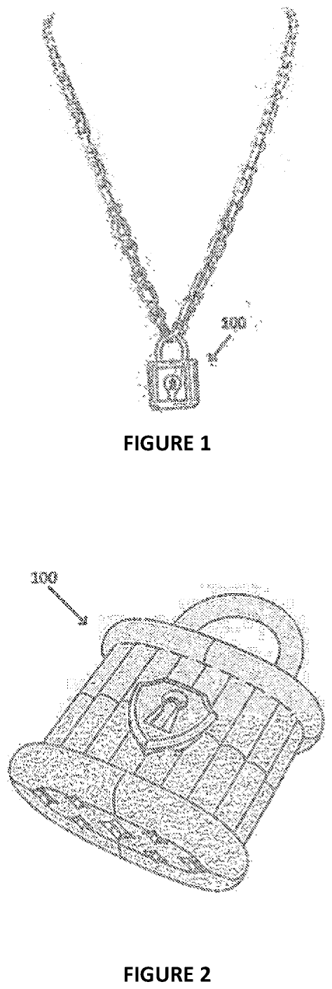

The complete view of the locking system (100) of the invention is given in FIGS. 1 and 2. The present invention relates to a locking system (100) that has a housing (120) and a spring (160) positioned in a body (110), as can be seen in all the figures.

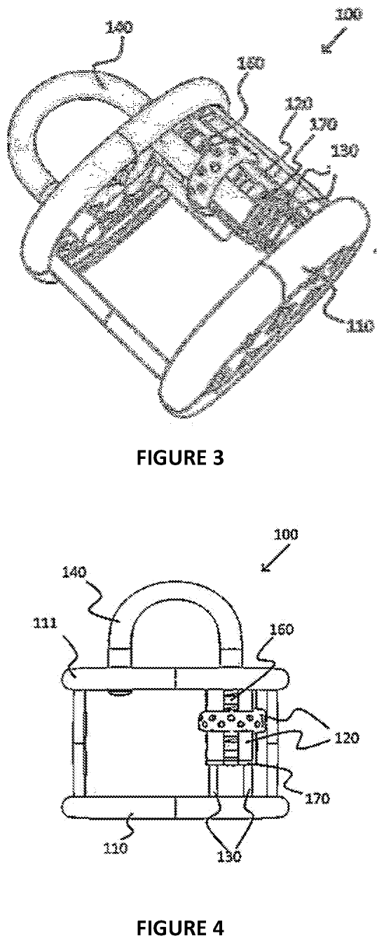

As seen in FIG. 3, the locking system (100) mainly comprises the following;
a locking element (140), on which a spring (160) is attached such that it is inside the housing (120), and provides locking,
at least one fixing element (150) that is engaged with the housing (120), enables the locking element (140) to be fixed to the housing (120),
at least one guide element (170) combined with the locking element (140), allows the spring (160) to remain on the locking element (140) and the locking element (140) to move in the housing (120) and
at least one ring (180) that is connected with the guide element (170) and the locking element (140) and ensures the fixation of the locking element (140) to the housing (120).

The locking system (100) further comprises a carrier element (130) that allows the housing (120) to be fixed to the body (110) and is engaged with the housing (120).

The spring (160) is engaged to the locking element (140) such that it corresponds to the spring section (141) located on the locking element (140). Subsequently, the guide element (170) is joined to the locking element (140) by means of welding, thus the spring (160) remains attached to the locking element (140). In the alternative embodiments of the invention, the shape of the locking element (140) can be changed according to the structure of the lock.

The fixing element (150) is positioned on the housing (120) by means of welding in a fixed manner. The locking element (140), the spring (160) and the guide element (170) are located in the housing (120), and then the ring (180) is fixed to the lock element (140) by means of welding.

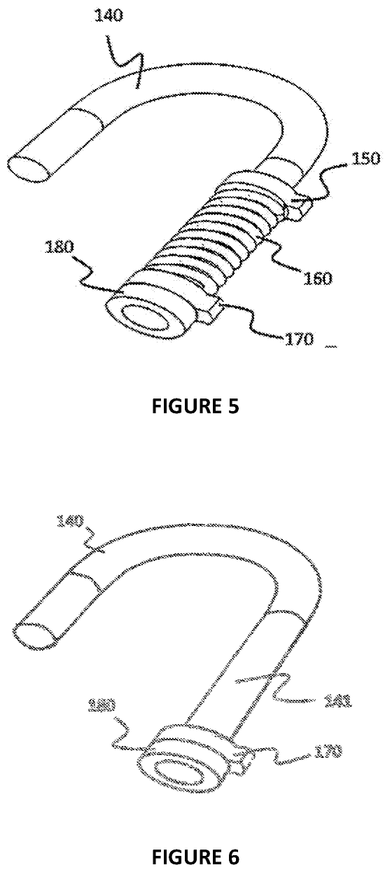

As seen in FIG. 5, the spring (160) reaches to the position between the fixing element (150) and the guide element (170). The locking element (140) reaches a capacity of rotating 360 degrees by means of the housing (120) and the guide element (170).

The fixing element (150) prevents the locking element (140) from coming out of the housing (120) and provides the same to remain within the housing.

Therefore, in case the locking element (140) is pulled manually, it compresses the spring (160) by moving upwardly in the channels in the housing (120). Therefore, while the locking element (140) moves upwards, it also gains the ability to rotate 360 degrees. When the locking element (140) that is moved manually reaches the level of the locking space on the upper body (111), it enters into the space and is locked with the force of the spring (160) when it is released.

FIG. 4 shows the locking element (140) that is locked on the upper body (111). The locking system (100) can be opened by pulling manually, and it can also be closed manually.

In the alternative embodiments of the invention, different assembly or combining methods can be used instead of the carrier element (130) so as to engage the housing (120) to the body (110).

1. A locking system that has a housing and a spring positioned in a body, characterized by comprising:
at least one locking element, on which the spring is attached such that it is inside the housing and provides locking,
at least one fixing element that is engaged with the housing, and enables the locking element to be fixed to the housing,
at least one guide element combined with the locking element, which allows the spring to remain on the locking element and the locking element to move in the housing, and
at least one ring that is connected with the guide element and the locking element, and ensures the fixation of the locking element to the housing.

2. A locking system according to claim 1, comprising a carrier element that allows the housing to be fixed to the body and is engaged with the housing.
